(19) United States
(12) Patent Application Publication
(10) Pub. No.: US 2023/0373880 A1
(43) Pub. Date: Nov. 23, 2023

(54) Agricultural product, and preparation method

(71) Applicants: INSTITUT NATIONAL POLYTECHNIQUE DE TOULOUSE, TOULOUSE (FR); INSTITUT NATIONAL DE RECHERCHE POUR L'AGRICULTURE, L'ALIMENTATION ET L'ENVIRONNEMENT, PARIS (FR)

(72) Inventors: Philippe EVON, TOULOUSE (FR); Carlos VACA-GARCIA, TOULOUSE (FR); Laurent LABONNE, TOULOUSE (FR); Antoine ROUILLY, TOULOUSE (FR)

(21) Appl. No.: 18/031,032

(22) PCT Filed: Oct. 15, 2021
(86) PCT No.: PCT/FR2021/051800

§ 371 Date: Apr. 10, 2023

(30) Foreign Application Priority Data
Oct. 16, 2020 (FR) 20/10597

(51) Int. Cl. C05G 5/40; C05C 9/00; C05F 3/00; C05G 3/40

(52) U.S. Cl. CPC C05G 5/40; C05C 9/00; C05F 3/00; C05G 3/44

(57) ABSTRACT

An agricultural product as well as its manufacturing method, the product being solid, disintegrable and including at least one agricultural active ingredient and one matrix based on a plant-origin material, the matrix having a plant protein content of at least 30% by weight relative to the dry weight of the plant-origin material and a lipid content of at most 10% by weight relative to the dry weight of the plant-origin material, and being present in the product in a proportion of at least 75% by weight relative to the weight of the product, and the agricultural active ingredient being dispersed, in a homogeneous way, in the matrix, the product having a density from 1300 to 1500 kg/m³.

### TECHNICAL FIELD

The disclosure concerns a solid, disintegrable, agricultural product, which comprises at least one agricultural active ingredient and a matrix based on a plant-origin material.

### BACKGROUND

The purpose of the disclosure is to provide a more effective and biodegradable alternative to agricultural products such as phytosanitary products and manures which are in a solid form and whose active ingredients are generally supported or integrated in a matrix. Some of these known products have the advantage of being poorly leachable thanks to a poorly dispersible matrix and therefore of gradually salting out their active ingredients, limiting the number of spreading operations by the farmer. They have the disadvantage of abandoning degradation products of the matrix which are not always rapidly biodegradable. Others have a matrix that is less resistant to moisture or water but, in return for this greater wettability, the active ingredient(s) are dissolved more quickly and the treatment must be repeated more often.

With an agricultural product according to the disclosure, a good compromise is reached between a controlled dispersibility of the active ingredient(s) and a matrix which does not leave any pollutant that cannot be assimilated by the soil and which may even be beneficial to it. It is the result of the development of a manufacturing method implementing extrusion technology which leads, in addition to the aforementioned properties, to a perfect dispersion of the active ingredient(s) in the matrix.

We know, according to document FR 2940297A1, a product manufactured by extrusion of a plant protein material having a protein content of at least 30% by weight and a lignocellulosic material content of at least 30% by weight relative to the dry matter, and of sulfite salts. Additives may be incorporated into the protein material at the moment of extrusion, some of which may have a role in plants. The product is obtained in the form of non-disintegrable granulates and may be used as material for manufacturing molded objects. However, in the absence of sulfite salts, it is impossible to obtain these granulates.

The document DE102004054790A1 describes a biodegradable manure comprising an intimate mixture, on the one hand, of a hydrophobic organic material, derived from plant or animal material and constituting a matrix, and on the other hand, of one or more mineral salts (up to 95% m/m, preferably 25-75% m/m) embedded in the matrix, said manure being in a hydrophobic plastic form resulting from its manufacturing method, giving said manure an ability to release in a controlled manner the nutrients resulting from the degradation of the organic material and the salts.

The document US2016/0264487A1 concerns a solid agricultural product comprising a matrix consisting of one or more co-products derived from the treatment of one or more lignocellulosic materials and nutrients (in particular N, P, K), and optionally additives, for example agricultural active ingredients such as fertilizers, pesticides, fungicides, herbicides, said product being intended to release said nutrients in a controlled manner, including those resulting from the degradation of the matrix, and optionally said active ingredients.

Despite the interest of such products, which make it possible to gradually release mineral salts and active ingredients under the effect of soil moisture without leaving, in significant quantities, non-biodegradable residues, the salting out of the phytosanitary and/or nutritive substances in the soil remains too fast. We are therefore still looking for new non-polluting agricultural products, which very gradually and completely release said substances so as to limit the number of spreading operations. The disclosure provides an effective solution to the aforementioned drawbacks.

### BRIEF SUMMARY

The disclosure provides a solid, disintegrable agricultural product comprising at least one agricultural active ingredient and a matrix based on a plant-origin material, said matrix having a plant protein content of at least 30% by weight relative to the dry weight of said plant-origin material and a lipid content of at most 10% by weight relative to the dry weight of said plant-origin material, and being present in said product in a proportion of at least 75% by weight relative to the weight of the product, and said agricultural active ingredient being homogeneously dispersed in said matrix, said product having a density of 1300 to 1500 kg/m³.

It was unexpectedly discovered that a product having a density in the selected range and which could have behaved as an inert product, is capable of releasing into the soil substances from the matrix and/or carried by the matrix according to a regularity appropriate to the treatment of the plants and making it possible to space the spreadings.

Before exposing the disclosure, certain terms used in this text are defined.

According to the disclosure, the expression “agricultural product” must be interpreted in the broad sense, in that it comprises any product intended for the treatment of a plant at any stage of its life, with a view its optimal development or the optimal development of one of its parts, in terms of yield and/or quality, or intended for the treatment of soil with a view to destroying or repelling organisms considered harmful, destroying undesirable plants, or its fertilization; with regard to the treatment of a plant, this concept therefore covers at least the protection of said plant against harmful organisms, in particular fungi, bacteria, viruses, insects, rodents, etc., —this is the function of pesticides —, the stimulation of its growth, its resistance to various stresses in particular the biotic and abiotic stresses, but also its nutrition. A treatment such as protection against harmful organisms or resistance to stress includes any mechanism of action of said product, whether by modification of the metabolism of the plant or by the biocidal properties of said product destroying or repelling the harmful organisms.

An agricultural product comprises one or more active ingredients chosen essentially from phytosanitary products and manures, acting in combination or not, in any physical form whatsoever, formulated or not, which may be natural substances of plant, animal, mineral origin or microorganism substances, or which may be obtained from a natural source where they are present or by chemical synthesis, and chemical, organic or mineral substances.

By matrix based on plant-origin material, it should be understood that the matrix is essentially and advantageously entirely made up of said material. However, this should not exclude the presence of substance which is not of plant origin, but which, for example, would unfortunately be present in said recycled material.

By plant-origin material, we mean in particular any material derived from plant production and in particular any by-product, but of course we include any material that may be found in the whole of the plant kingdom whether it exists as such in the natural environment, we will then speak of plant-origin raw material, or whether it is the result of one or more transformations of a plant-origin raw material. Thus the disclosure will be more particularly described with reference to a matrix based on cakes of oil crops such as sunflower and rapeseed or of protein-oil crops such as soybeans which, according to the disclosure, will find another outlet than that of the animal nutrition where they are widely recycled. However, the scope of the disclosure is not restricted to the use of these agri-food by-products, it extends in particular to the recycling of any by-product from the cereal industry.

The cakes are the solid by-products obtained after extracting the oil from the seeds of oil crops and protein-oil crops. The seeds, previously dehulled or not, undergo a trituration treatment consisting of crushing and pressing operations with means and under conditions, in particular of temperature and pressure, which are variable and specific to the oil manufacturing industry. This trituration phase may be followed by other treatments, in particular to increase the oil yield, for example solvent treatment. At the end, the cakes are recovered in the form of a paste and then dried.

The cakes, optionally enriched with proteins, derived from sunflower, soybean, flax and rape seeds are representative of this technical field.

The term “disintegrable” means according to the disclosure that the product of the disclosure is disaggregated at least under the influence of soil moisture. The disaggregation period depends mainly on the nature of the matrix, its proportion in the product, the densification rate of the product and of course the moisture content which may go up to the maximum, i.e. when the soil is flooded. Even under these extreme conditions, it will be demonstrated that the product of the disclosure is effective. It emerges from the manufacturing method that the disaggregation of the product is homogeneous and leaves only compounds that can be assimilated by the soil or by the plants, some of which contribute to the nutrition or health of the soil and/or of said plants.

By homogeneously dispersed in the matrix, it is understood that the active ingredient is included in the matrix (i.e. incorporated, supported, integrated, encapsulated or any other term meaning that the active ingredient is included in the matrix and that it forms an assembly with the matrix in such a way that it is included in a homogeneous manner in the latter without it being a question of a “core/shell” type encapsulation) and that it comes into contact with the soil, then with the plant if necessary, as soon as the product begins to disaggregate and this, in a regular way, until the complete disintegration of the product. This characteristic is obtained thanks to an optimal mixture of the plant-origin material and of the active ingredient(s) at least, guaranteed by the extrusion and the densification implemented in the manufacturing method according to the disclosure. This is how we can speak about controlled diffusion of said active ingredient.

In the present text, according to preferred variants, the product of the disclosure is characterized by physical properties, the methods for measuring these properties are indicated below, by an accuracy of the reference standard for standardized tests and a description of the measurement protocol for non-standardized tests:

The density of the product was measured by pycnometry using a 50 mL pycnometer made of borosilicate glass 3.3 from LMR® and cyclohexane as immersion liquid, at room temperature.

To measure the density of the product, test pieces 80 mm long, 10 mm wide and 4 mm thick were first equilibrated in a climatic chamber (60% RH, 25° C.) for three weeks. After equilibration, their thickness and width were measured at three points, and their length at two points, using a digital caliper (0.01 mm resolution). The average values of thickness, width and length were recorded to calculate the volume of the sample, and the test pieces were all weighed to calculate their density.

The abrasion resistance was determined as follows:

A cylindrical container having a diameter of 115 mm and a height of 130 mm was used. The bottom of the container was fixed to an axis, inclined 15° upwards relative to the horizontal and rotating by means of a motor at a speed of 80 rpm. About 30 g of product as parts having the dimensions 10 mm×10 mm×4 mm, were positioned inside the container before the start of the test. During the test, ten metal parts, for a total mass of 125 g, were also placed inside the container, their addition aiming to simulate the mechanical abrasion to which the parts will be subjected during their spreading in the field. Two wooden blades of the same length as the height of the container, both 1 cm high and 1 cm wide, were fixed inside the cylinder at 180° from each other. Here, their goal was to amplify the effect of the mechanical abrasion on the tested sample by the metal parts. The duration of the test was 1 hour. At the end of the test, the material produced by the abrasion was recovered and then sieved on a 2 mm grid in order to quantify the fines generated during the test. The level of fines representing the percentage of weight loss of the sample at the end of the test is the ratio of the mass of fines generated during the abrasion test to the initial mass of the analyzed sample (in %). The abrasion resistance is obtained by subtracting 100% of the level of fines.

The tensile elastic modulus (Ey expressed in MPa) is determined according to ISO standard 527-4:1997.

The bending elastic modulus (Er expressed in MPa) is determined according to ISO standard 178:2010.

The Shore D surface hardness)(° is determined according to ISO standard 868:2003.

The caking after immersion in water is measured by weighing the sample before and after immersion, according to the ISO standard 16983:2003.

As said above, the matrix based on plant-origin material has a plant protein content of at least 30% by weight relative to the dry weight of said plant-origin material. Below such a concentration, the plant-origin material of the matrix is insufficiently melted during the method of manufacturing the product, which makes the method more complicated and less efficient. Depending on the source of the plant-origin material, the plant protein content may be at least 35% (w/w) or at least 40% (w/w) and even at least 42% (w/w). Thus, the plant-origin material is preferably chosen from legumes, but also from the seeds and fruits of oil crops and protein-oil crops. According to the disclosure, the plant-origin material may have been enriched with proteins by any appropriate technique well known to those skilled in the art. It will be preferred to carry out this enrichment by extraction of any other fraction of the material, such as the lipid fraction, using solvents for example. The protein content may reach 70%, even 75%, or 80% (w/w), without affecting the performance of the product manufactured according to the disclosure. It preferably does not exceed 90% (w/w). Advantageously, the matrix is obtained from cake(s) chosen from among sunflower cakes, legume cakes such as soybean, flax cakes, crucifer cakes such as rapeseed and any mixture of these cakes, the cake(s) having been optionally enriched with protein. It is within the general knowledge of a person skilled in the art to enrich a cake with proteins, and in particular soybean and sunflower cakes, the enrichment of which may reach 90% (w/w). The manufacturing method of the disclosure is efficient when the protein content of matrix based on plant material reaches 30% (w/w), which constitutes an economic interest, certain cakes satisfying this condition without resorting to an additional enrichment, others not satisfying this condition requiring only an additional enrichment step implemented without excessive additional cost.

The lipid content must be limited to a value of at most 10% by weight relative to the dry weight of the plant-origin material. Beyond such a concentration, the product obtained at the outlet of the extruder lacks cohesion and is disaggregated; this drawback may not even be circumvented by a step of densifying the product according to a variant of the method of the disclosure, the densified product obtained having very insufficient mechanical properties and very low abrasion resistance. This value of 10% is generally not reached in plant-origin raw materials, nor even in many agri-food by-products such as cakes. Of course, this content may be lowered for example by physical or chemical extraction.

The plant-origin material may of course contain other fractions linked to its source, such as cellulose, hemicelluloses, water-soluble fractions, minerals.

The product may also comprise at least one additive, in particular with a view to improving its performance and/or its manufacturing method. By way of illustration, said additive may be chosen from lubricating agents such as an oil, matrix plasticizing agents such as glycerin, water, and cohesion agents such as starch. The choice and amounts of additives may be determined by those skilled in the art and depend on the reactants and the desired product. In general, the contents of additives do not exceed 20% by weight relative to the weight of the product.

A matrix is preferably present in said product in a proportion of at least 75% by weight relative to the weight of the product, guaranteeing an agricultural active ingredient content of up to 25% (w/w), which represents a high concentration. In a variant of the disclosure, the proportion of the matrix is at least 80% (w/w), preferably it ranges from 83% to 95% by weight relative to the weight of the product. The proportion of the active ingredient(s) in the product of the disclosure then varies from 5% to 25% (w/w).

In a preferred product of the disclosure, all or part of the plant-origin material is in a form resulting from a transition into the molten state. Indeed, the method of the disclosure described later in the text is advantageously carried out under conditions which allow melting of the proteins at least, or of a major part of said material and even of all the material. This contributes to an optimal mixing of the matrix with the active ingredient(s) and additives when they are present.

A product of the disclosure is solid, it comes in any desired form, for example in the form of granules, tablets or pellets. Advantageously, it meets at least one of the physical properties, or several and even all of them: abrasion resistance at least equal to 98%, tensile elastic modulus at least equal to 200 MPa and less than 1850 MPa, bending elastic modulus at least equal to 85 MPa and less than 1500 MPa, Shore D surface hardness between 37.5° and 70°, caking from 35% to 60% after immersion in water for 1 hour, from 60% to 100% after 3 h, and from 100% to 160% after 6 h.

The agricultural active ingredient(s) may be chosen from any phytosanitary ingredient and any manure and in particular fertilizers, natural defense stimulators, pesticides (such as herbicides, fungicides, insecticides, parasiticides), repellents, and are preferably chosen from or derived from natural substances of plant, animal, microbial or mineral origin. By way of example, we can mention the flour, like plant flour such as grain, seed or root flour or animal floor such as feather, fish or horn meal. A product of the disclosure may also comprise any mixture of said ingredients and/or manures. The method for manufacturing a product of the disclosure makes it possible to incorporate any solid, liquid or pasty ingredient, formulated or not, diluted or not. The agricultural active ingredient(s) may more particularly be chosen from fertilizers, preferably nitrogen fertilizers, also called nitrogen manures. In a preferred embodiment of the disclosure, the active ingredient is urea.

During the development of the present disclosure, it was discovered that urea, conventionally used as a nitrogen manure and which may be introduced as such into a matrix as described above, also behaves as an additive promoting the shaping of the product. Thus, a product of the disclosure may comprise urea, preferably in a proportion from 5% to 25% and most preferably from 5% to 20% by weight relative to the weight of the product, the urea behaving both as an active ingredient and as an additive. Of course, it may be present in the product in association/combination with any other active ingredient and/or any other additive, regardless of the properties of said active ingredient or said additive. Given its plasticizing role, the higher its proportion, the more fluid the mixture becomes, and if its proportion exceeds 25%, the mixture becomes too fluid and its extrusion less easy.

The disclosure further provides a method for manufacturing an agricultural product as defined above which is implemented in a twin-screw extruder comprising a barrel inside which are disposed two co-penetrating (or interpenetrating) and co-rotating parallel screws, and equipped with at least two inlets for feeding, an outlet of the extruded product and heating elements, said extruder being optionally associated with a die for forming the extruded product, and which comprises the following steps:
introduction of at least one plant-origin material and one agricultural active ingredient, and optionally one or more additives, into a first feed inlet of said extruder and premix of them by the action of interpenetrating conveyor screws;
addition of water, and optionally one or more additives, to the premix through a second feed inlet;
heating to a temperature of at least 80° C. to obtain a homogeneous mixture;
application of compressive, kneading and shearing stresses to said mixture by action of the screws; and
densification of the product recovered at the outlet of the extruder or die, to obtain said agricultural product.

Optional characteristics of the method are indicated below, said characteristics being able to be considered alone or in any combination.

At the step of introducing the essential constituents of the product which will constitute the premix, the plant-origin material is introduced in a proportion of at least 75% by weight relative to the weight of the premix and the active ingredient(s) in a proportion of at most 25% by weight relative to the weight of the premix. One or more additives may also be added at this step. The essential constituents are conventionally metered by means of weight metering devices.

Then water is added to the premix in a proportion of 20% to 50% by weight relative to the weight of the premix. If the product contains one or more additives, they are more practically introduced at this step. Depending on their function, their form, one or some of the additives may be added at the step of introduction of the essential constituents, and others added at this step.

For the purpose of optimal mixing conditioning the qualities of the manufactured product, the extruder is equipped with several series of decrease pitch conveyor screws, making it possible to apply the compressive stresses to said mixture. To this end, the extruder is advantageously equipped with two successive pairs of bilobed kneading discs, mounted in a staggered fashion, making it possible to apply the kneading constraints to said mixture, said discs being disposed following, directly or indirectly, the decrease pitch conveyor screws. According to this variant, the extruder is provided with several successive pairs of reverse pitch elements (or counter-threads), preferably four, making it possible to apply the shearing stresses to said mixture, said elements being disposed following, directly or indirectly, said discs.

An optimized implementation of a method of the disclosure must guarantee that the following and consecutive stresses are applied to the mixture along the extrusion screw: compression, kneading, compression, shearing.

Even if the product recovered at the outlet of the extruder may be in bulk, it is preferable that the extruder be associated with a die, itself completed with a die-head pelletization system, allowing the product to be shaped, that is to say in the form of regular parts, such as calibrated granules, which will promote its flowability and its storage in bags for example. In addition, the product must undergo a densification treatment, its introduction into the equipment will be facilitated if it is in the form of regular and homogeneous parts, such as calibrated granules.

In more detail and by way of illustration, a description of the different phases of an extrusion implemented in a method according to the disclosure is as follows:

After metering then introduction through the inlet provided for feeding the constituents of the product, the plant-origin material and the active ingredient(s), or even one or more additives, are swallowed at room temperature (20-25° C.) by conveyor elements located at the start of the screw profile, of the double-threaded conveyor element type and of trapezoidal profile (known as T2F) first in order to guarantee good swallowing then of the double-threaded and conjugated profile conveyor element type (known as C2F). Then, at the same time as the C2F elements see their pitch gradually decrease, helping to apply a progressive action of compression to the mixture of the two constituents, the temperature is increased to 80° C., and water is introduced using a piston pump. The objective here is to facilitate the flow of the solid mixture along the barrel. In addition to its plasticizing action on the proteins of the plant-origin material, water also helps dissolve the active ingredient before it is dispersed in a homogenous manner within the plant-origin material. Advantageously, the amount of water added is between 25% and 50% by weight relative to the weight of the premix consisting of the plant-origin material, the active ingredient(s) and optionally the additive(s), preferably between 30% and 40%.

If necessary, sodium sulfite is added to the water (1 kg per 10 kg of water) in order to guarantee a reduction of the disulfide bridges linking the cysteine residues together along the protein chains of the plant material. In doing so, the proteins will be better destructured/plasticized, guaranteeing a better deployment of their chains in space and a rheology, during their melting, lowered. Then, the temperature of the barrel is increased to 100° C. and two consecutive series of bilobed kneading discs mounted in staggered fashion are positioned along the screw profile; their objective is threefold: to finalize the dissolution of the active ingredient in water, to ensure complete impregnation of the water in the plant-origin material and to obtain the most homogeneous dispersion possible of the active ingredient in the plant-origin material. Downstream of the kneading elements, the mixture is then taken up by conveyor elements, first of high pitch in order to relax the mixture. Then, the C2F elements see their pitch decrease, leading to a slight compression effect on the mixture. Finally, reverse pitch elements of counter-threaded, double-threaded and conjugate profile type (known as CF2C) are positioned along the screw profile. The strong mechanical shear thus applied to the mixture makes it possible to finalize the destructuring/plasticization of the proteins within the plant-origin material, these then transitioning into a viscous rubbery state, as well as the dispersion of the active ingredient in plant-origin material. Advantageously, at least two successive pairs, preferably four pairs, of CF2C elements are used to carry out these two operations.

Immediately after the reverse pitch elements (CF2C), the plasticized homogeneous mixture undergoes rapid relaxation, thanks to the installation of long pitch conveyor elements (C2F). Then, the screw profile continues with a reduction of the C2F elements which once again contribute to slightly compress the mixture.

At the end of the screw profile, a front plate and a circular food die are positioned in the extension of the barrel. The mixture may thus be extruded in the form of strands which are then die-head pelletized using a pelletizer knife. It is then densified.

The product thus manufactured consists of a thermo-mechanical-chemically destructured plant-origin material, including plasticized proteins, in which the active ingredient is distributed homogeneously.

Advantageously:
the die inserts are in a conical shape, with an outlet diameter of between 2 and 4 mm, preferably close to 3 mm;
the number of inserts placed in die is chosen so that the solid flow rate per insert is between 8 and 14 kg/h, preferably between 10 and 12 kg/h.

The speed of rotation of the pelletizer knife is adjusted to make it possible to control the length of the granule to a value as close as possible to its diameter.

The product thus manufactured consists of a thermo-mechanical-chemically destructured plant-origin material, including plasticized proteins, in which the active ingredient is distributed homogeneously.

After pelletization at the outlet of the die, the product of the disclosure contains a moisture of between 25% and 30%; according to an advantageous variant, it is dried to a moisture of the order of 15% to 20% by weight relative to the weight of the product, in order to facilitate its densification. To this end, the method may comprise a drying step carried out continuously using a belt dryer ensuring the drying by circulation of a stream of hot air through the belt on which the product is deposited. Advantageously, the product is distributed in a uniform layer over the entire width of the belt to ensure homogeneous drying.

To implement an advantageous mode of the method of the disclosure, the active ingredient contains or consists of urea. As said before, urea acts both as an active ingredient and as an additive contributing to the efficiency of the extrusion. The method may therefore comprise a step of adding urea, preferably in a proportion of 5% to 25%, most preferably of 5% to 20%, by weight relative to the weight of the premix, the urea possibly being introduced in the step of introducing the plant-origin material and/or in the next step of adding the additive(s).

The densification of the product may be carried out by any method, the latter falling within the general knowledge of a person skilled in the art. Thus, it may be made by thermoplastic injection or hot compression.

During the step of plastic injection of the product, the product is gradually heated to a temperature of between 110° C. and 140° C., then is injection molded.

In a preferred implementation, the product to be densified is the result of extrusion and then of passage through a die.

A description of this additional step is given below, solely by way of illustration and without the intention of restricting a method of the disclosure to this implementation.

Before the densification step exemplified by injection, the moisture content of the product obtained after extrusion is adjusted to a value advantageously between 15% and 20%. Then, it is introduced into the feed hopper of the injection machine. Of constant pitch along its entire length, the so-called plasticizing screw has a reduced length/diameter (L/D) ratio, advantageously of between 18 and 25, preferably comprised around 20. Furthermore, this plasticizing screw advantageously has a lowered compression ratio (from 1.8 to 2.5), preferably close to 2.0.

During injection, the metering of the product is first carried out along the plasticizing screw. Selected by the operator, the metering stroke must correspond to a volume of melted material of the order of 10% greater than the volume of the mold cavity to be filled.

During metering, along the plasticizing screw, in addition to the mechanical shearing applied during its rotation, the product is gradually heated from 70° C. to 110° C. in order to guarantee its transition into the molten state. Once melted, the product is then metered at the end of the barrel. Then, it is injected inside the mold, itself locked thanks to the closing unit of the injection molding machine.

For injection, the product is pushed through the nozzle located in the extension of the barrel, at a temperature advantageously of between 120° C. and 140° C., preferably equal to 130° C. The injection into the mold cavity is made possible thanks to the advance of the plasticizing screw which then acts like a real piston.

In order to promote rapid cooling of the solid product in the mold cavity, the latter is regulated at a temperature advantageously of between 20° C. and 50° C., preferably at a temperature of between 30° C. and 40° C. Then, the mold is opened and the injected parts are then ejected out of the mold cavity.

The injected parts then undergo gentle drying to a moisture advantageously less than 15%, preferably of between 8% and 12%, in order to allow them to be stored without risk of development of fungi or mold.

The disclosure concerns the use of a plant-origin material which has a plant protein content of at least 30% relative to the dry weight of said material and a lipid content of at most 10% reactive to the dry weight of said material, as a disintegrable matrix to support an agricultural active ingredient.

The disclosure also concerns the use of urea as a plasticizing agent for the manufacture in a twin-screw extruder of an agricultural product as defined above.

### BRIEF DESCRIPTION OF THE DRAWINGS

The disclosure is illustrated with the following examples from which its advantages will emerge and in support of the following FIGS. 1 to 8:

FIG. 1 represents the nitrogen salting out rate from urea by different products.

FIG. 2 represents the fresh weight of spinach leaves from cultures treated with different products.

FIG. 3 represents the dry weight of spinach leaves from cultures treated with different products.

FIG. 4 represents the fresh weight of spinach roots from cultures treated with different products.

FIG. 5 represents the dry weight of spinach roots from cultures treated with different products.

FIG. 6 represents the amount of chlorophylls (chlorophyll a (Ca) and chlorophyll b (Cb)) and carotenoids accumulated in the spinach leaves from cultures treated with different products.

FIG. 7 represents the amount of nitrogen accumulated in the spinach leaves and roots from cultures treated with different products.

FIG. 8 represents the amount of nitrates accumulated in the fresh spinach leaves from cultures treated with different products.

### DETAILED DESCRIPTION AND EXAMPLES

### Example 1: Properties of Products of the Disclosure

Products of the disclosure, PTUd, PSUd and PLUd, comprising a matrix consisting of, respectively, sunflower (T), soybean (S) and flax (L) cake (91% w/w) and urea (U) (9% w/w) as active ingredient are manufactured and their properties are compared with those of three reference products PT, PS and PL (outside the disclosure) composed of a matrix consisting of cakes, not containing active ingredient and not being densified, as well as these three densified products PTd, PSd and PLd.

Matrices are prepared from the following cakes respectively:
sunflower cake enriched with protein by simple sieving of a sunflower industrial cake
soybean cake obtained by solvent oil extraction, and
flax cake obtained by first cold pressing of flax seeds.

Their protein and lipid contents are given in table 1 below: they are expressed in % by weight relative to the weight of the dry matter.

TABLE 1

Cake

| Fraction | Enriched sunflower (T) | Soybean (S) | Flax (L) |
|---|---|---|---|
| Proteins | 50.7 | 46.0 | 37.0-42.0 |
| Lipids | 1.4 | 2.2 | 7.7 |

The products PTU, PSU and PLU, respectively, are manufactured by extrusion according to the technology involved and described previously.

The products PTUd, PSUd and PLUd of the disclosure are obtained by densification of the PTU, PSU and PLU products, respectively, by plastic injection, according to a variant of the method of the disclosure described above.

The reference products PT, PS, PL, PTd, PSd and PLd, not containing active ingredient, are manufactured using the same methods.

1.1 Characterization of the Products of the Disclosure by their Physico-Chemical and Mechanical Properties

The values of the non-densified products and of the densified products according to the disclosure are grouped in table 2 below.

TABLE 2

| Product | PTU | PTUd | PSU | PSUd | PLU | PLUd |
|---|---|---|---|---|---|---|
| Density (kg/m³) | 1122.5 | 1398.2 | 702.5 | 1406.9 | 881.9 | 1361.1 |
| Abrasion | 88.5 | 99.6 | 82.5 | 99.3 | 92 | 98.7 |
| resistance (%) | | | | | | |
| Tensile elastic | nd | 476 | nd | 224 | nd | 216 |
| modulus Ey (MPa) | | | | | | |
| Bending elastic | nd | 295 | nd | 133 | nd | 91 |
| modulus Ef (MPa) | | | | | | |
| Shore D hardness | nd | 46.9 | nd | 48.9 | nd | 37.7 |
| (°) | | | | | | |

nd: not determined

1.2. Test of Salting Out Nitrogen from the Active Ingredient by Products of the Disclosure

The salting out of nitrogen by the products PTUd, PSUd and PLUd is measured after immersion of the products in water contained in a tray, for 1 hour and for 3 hours, respectively. At the end of immersion, the products are removed from the tray and are then left to drain completely on a metal grid. The liquid resulting from this draining is recovered, filtered in order to eliminate any solid particles in suspension and weighed. Finally, the part of nitrogen present in this liquid is metered using the Kjeldahl method according to the ISO standard 5983-1:2005.

The reference products PTd, PSd and PLd were subjected to the same treatment. The part of nitrogen which could be measured in the liquid resulting from the draining necessarily comes from the proteins present in the plant-origin material.

The quantity of nitrogen salted out respectively by the products of the disclosure PTUd, PSUd and PLUd coming specifically from urea is calculated by subtracting the quantity of nitrogen metered in the draining liquid of the reference products PTd, PSd and PLd to that metered in the draining liquid of the products of the disclosure PTUd, PSUd and PLUd.

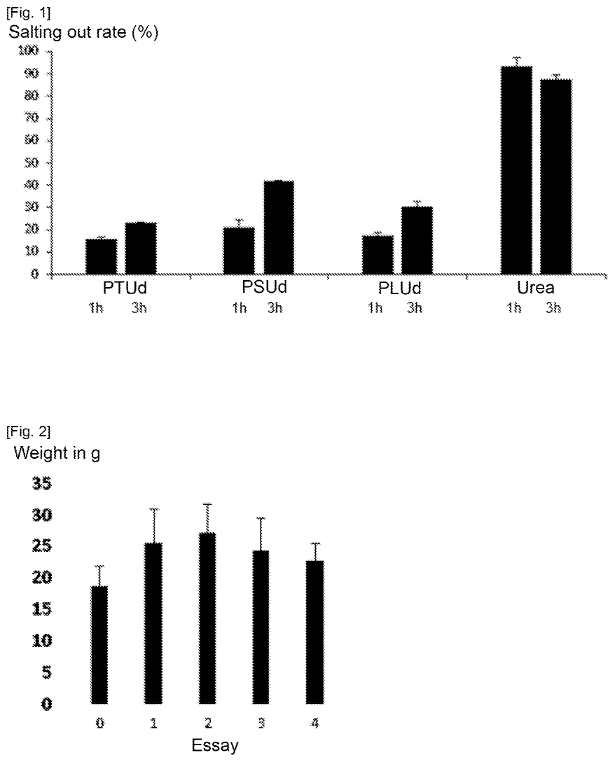

The results of the metering of the nitrogen in the products of the disclosure are presented in FIG. 1.

These results demonstrate, on the one hand, the effectiveness of the “encapsulation” of urea in a matrix based on plant matter according to the method of the disclosure with respect to the salting out of nitrogen and, on the other hand, the control of the diffusion of urea, the latter not being accelerated over time and remaining progressive.

1.3. Test of Immersion in Water of Products of the Disclosure

The tests were conducted on the products PTUd, PSUd and PLUd of the disclosure, as well as on the products PT, PS and PL, the products PTd, PSd and PLd and the products PTU, PSU and PLU, all defined at the beginning of example 1, and the compared results. They are reported in Table 3 below.

TABLE 3

| | | Caking after immersion in water (%) | | | |
|---|---|---|---|---|---|
| Formulation | — | 1 h | 3 h | 6 h | 24 h |
| PT | Average | 79.5 | 85.8 | Disintegrated | Disintegrated |
| | ± | 0.4 | 4.2 | | |
| PTd | Average | 40.4 | 61.1 | 98.3 | 119.3 |
| | ± | 1.6 | 1.1 | 4.5 | 3.0 |
| PTU | Average | 142.9 | 151.9 | Disintegrated | Disintegrated |
| | ± | 1.6 | 2.7 | | |
| PTUd | Average | 37.0 | 78.4 | 111.4 | 157.0 |
| | ± | 1.0 | 10.0 | 23.4 | 25.8 |
| PS | Average | 204.3 | 207.6 | Disintegrated | Disintegrated |
| | ± | 0.4 | 1.6 | | |
| PSd | Average | 45.2 | 75.9 | 120.2 | 162.3 |
| | ± | 1.2 | 1.0 | 4.1 | 16.5 |
| PSU | Average | 142.1 | 152.3 | Disintegrated | Disintegrated |
| | ± | 3.3 | 0.1 | | |
| PSUd | Average | 57.1 | 95.5 | 156.0 | 212.7 |
| | ± | 0.5 | 1.5 | 21.0 | 26.0 |
| PL | Average | 170.0 | 233.5 | Disintegrated | Disintegrated |
| | ± | 2.9 | 2.8 | | |
| PLd | Average | 54.2 | 60.4 | 126.1 | Partially |
| | ± | 1.2 | 1.1 | 20.0 | disintegrated |
| PLU | Average | 196.1 | 247.8 | Disintegrated | Disintegrated |
| | ± | 2.6 | 4.7 | | |
| PLUd | Average | 49.0 | 78.1 | 159.0 | Partially |
| | ± | 3.3 | 7.2 | 16.3 | disintegrated |

The following observations emerge from these results:
when it can be measured, that is to say when the product is not yet disintegrated, the caking in water is always lower for the products of the disclosure compared to the non-densified products outside the disclosure, for the same formulation, right from the start;
after 6 hours of immersion, only the products of the disclosure have not yet disintegrated.

### Example 2: Efficacy Test in the Salting Out of an Active Ingredient of Manure Type from a Product of the Disclosure on a Spinach Cultivation

It is known that the cultivation of spinach requires a sufficient supply of nitrogen manure to ensure optimal growth of the leaves which are intended for human consumption.

2.1 Equipment and Methods of Agronomic Tests

Spinach (Spinacia oleracea L.) was sown on a commercial substrate of Evergreen TS (Turco, Italy) type cultivation. The plants were cultivated in a greenhouse under natural light conditions. When the first two leaves appeared, the plants were transplanted to the substrate in 2 L (13 cm×13 cm×13 cm) pots (5 plants per pot and 5 pots per essay).

After one week, the manures were added according to the scheme described below:
Essay No. 0: control (culture substrate alone); it is a control essay without fertilization;
Essay No. 1: culture substrate+PTd (4 g per pot, 277 mg N);
Essay No. 2: culture substrate+PTUd (2.5 g per pot, 285 mg N), this is a fertilization essay with a product according to the disclosure;
Essay No. 3: culture substrate+urea (0.25 g per pot, 50 mg N);
Essay No. 4: Osmocote® (1.5 g per pot, 285 mg N); this is a control essay with the addition of an Osmocote® PRO 3-4 slow-release commercial manure (NPK) (ICL Italia Treviso, Italy), implemented at the dose recommended by the manufacturer.

The amount of manures PTd and PTUd added to each pot, for essays No. 1 and No. 2 respectively, was calculated in order to introduce the same amount of nitrogen as in the control essay No. 4. The essay No. 3 contained the same amount of urea as the essay No. 2.

At the end of the experiment, the plants were all healthy and had reached a satisfactory size with no apparent difference between the essays.

After 55 days, the leaves and roots were collected, and their respective fresh weights were measured. Two plants per pot were dried at 60° C. until reaching a constant weight for the determination of the dry weight of the leaves and roots.

The chlorophyll content was determined on the fresh leaves from two plants per pot. The N content of dry leaves and roots was measured after crushing by elemental analysis.

The performance indicators of the tested products were (i) the production of biomass (leaves and roots), (ii) the content of chlorophyll and carotenoids, (iii) the total concentration of nitrogen and (iv) that of nitrates.

2.2 Results obtained

2.2.1 Effects on the Fresh Weights and the Dry Weights of the Leaves

The results are reported in FIG. 2 (fresh weight) and FIG. 3 (dry weight).

With nitrogen fertilization (essays No. 1 to No. 4), the average dry weight of the leaves is 2.2 g/plant against only 1.6 g/plant for the control carried out without fertilization (essay No. 0).

It is observed that the essay No. 2 (product according to the disclosure) leads to the highest fresh weights and dry weights of leaves. This result demonstrates a proven (and cumulative) fertilizing effect of the product PTUd resulting from the nitrogen supply by (i) urea salted-out but also (ii) its proteins, present at 51% of its dry mass.

2.2.2 Effects on the Fresh Weights and the Dry Weights of the Roots

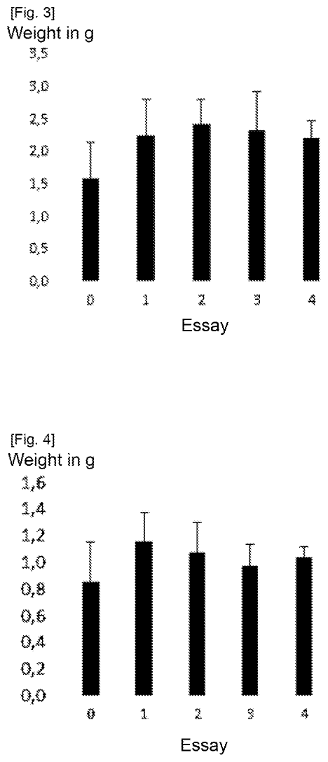

The results are reported in FIG. 4 (fresh weight) and FIG. 5 (dry weight).

With nitrogen fertilization (essays No. 1 to No. 4), the recorded average values are slightly higher than with the non-fertilized essay (essay No. 0). Nevertheless, the differences observed are not significantly different and no relationship between the root/leaf ratio (with an average value of 0.06) and nitrogen fertilization has been demonstrated.

2.2.3 Effects on the Chlorophyll Content

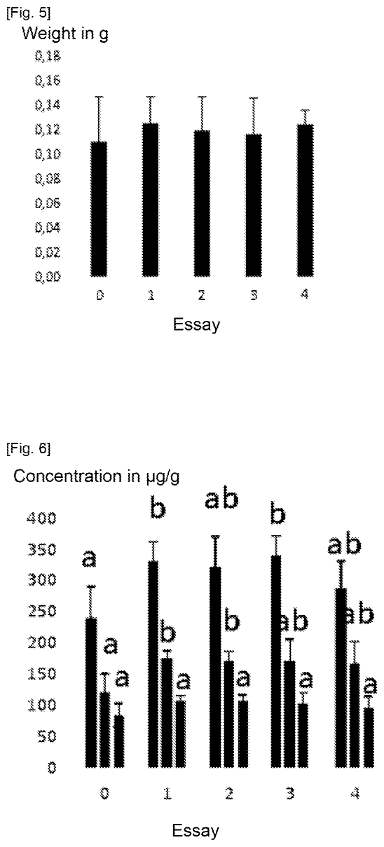

The contents of chlorophyll a (first bar of each essay in the histogram), chlorophyll b (second bar of each essay in the histogram) and carotenoids (third bar of each essay in the histogram) in the leaves are reported in FIG. 6. Despite high standard deviations, these contents remain higher in the case of nitrogen fertilization (essays No. 1 to No. 4) than for the control essay (essay No. 0). The use of PT, without or with urea (essays No. 1 and No. 2, respectively), comparable to that of urea alone (essay No. 3), is even beneficial in comparison with the tested commercial manure (essay No. 4).

2.2.4 Effects on the Nitrogen Content of the Leaves and Roots

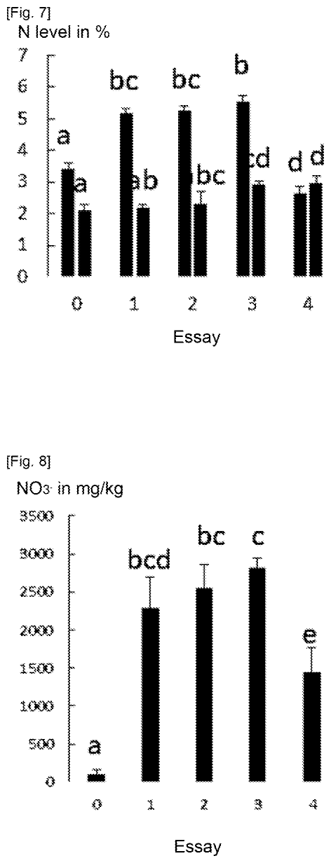

FIG. 7 shows that the nitrogen uptake by the leaves (first bar of each essay in the histogram) of the plants fertilized with TP-based samples (essay No. 1 and No. 2) or with pure urea (essay No. 3) is higher than in the cases of the control essay (essay No. 0) and even of the plants fertilized with the Osmocote® commercial manure (essay No. 4). The uptake of N by the roots (second bar of each essay in the histogram) is on average lower than that of the leaves.

The high N content of the leaves implies a high protein concentration and therefore a cultivation with better nutritional value.

2.2.5 Effects on the Nitrate Content of the Fresh Leaves

FIG. 8 shows that the fresh leaves of the control plants (essay No. 0) have the lowest nitrate content, followed by the fresh leaves of the plants fertilized with Osmocote® (essay No. 4). Conversely, the fresh leaves of the plants fertilized with PTd (essay No. 1), PTUd (essay No. 2) and pure urea (essay No. 3) have much higher nitrate contents.

It should be remembered that the accumulation of nitrates in spinach leaves may be critical. The European Commission has indeed published a regulation (No. 1258/2011, Eur-lex, 2011) fixing the maximum acceptable concentration of nitrates in spinach at 3500 mg NO₃⁻/kg in fresh spinach, 2000 mg NO₃⁻/kg in canned or frozen spinach, and 200 mg NO₃⁻/kg in baby food.

The urea added at a dose of 0.25 g (essay No. 3) therefore has a negative impact due to the higher nitrate content in the fresh leaves of the plants. This content is reduced by replacing the urea with PTUd (essay No. 2) or with PTd (essay No. 1).

It is therefore observed that the nitrate content in the fresh leaves of plants treated with a product of the disclosure (PTUd) is always well below the maximum value of 3500 mg NO₃⁻/kg of fresh leaves tolerated by European regulations.

These examples demonstrate that a product of the disclosure, despite a low disintegration speed, brings a gain to the treated plants greater than that of products outside the disclosure and in particular than that of non-densified products. This effect is surprising. It has thus been demonstrated the benefit conferred by products of the disclosure in the field of agriculture, compared to the products of the prior art.

In conclusion, an agricultural product according to the disclosure makes it possible to reduce the amount of active ingredient without compromising plant growth. In addition, it allows to reduce the negative impact on the environment and on human health, caused by a high applied dose of active ingredient.

1. A solid, disintegrable agricultural product comprising
at least one agricultural active ingredient and
a matrix based on a plant-origin material,
said matrix having a plant protein content of at least 30% by weight relative to the dry weight of said plant-origin material and a lipid content of at most 10% by weight relative to the dry weight of said plant-origin material, and being present in said product in a proportion of at least 75% by weight relative to the weight of the product, and said agricultural active ingredient being dispersed, in a homogeneous way, in said matrix,
wherein said product has a density of 1300 to 1500 kg/m³.

2. The agricultural product according to claim 1, wherein the matrix has a plant protein content of at least 35% in weight relative to the dry weight of said plant-origin material.

3. The agricultural product according to claim 1, wherein the matrix is obtained from cake(s) chosen from among sunflower cakes, legume cakes, soybean, flax cakes, crucifer cakes, rapeseed and any mixture of these cakes, the cake(s) having been optionally enriched with protein.

4. The agricultural product according to claim 1, wherein all or part of the plant-origin material is in a form resulting from a transition into the molten state.

5. The agricultural product according to claim 1, wherein the proportion of the matrix is at least 80% by weight relative to the weight of the product.

6. The agricultural product according to claim 1, wherein the proportion of the agricultural active ingredient(s) ranges from 5% to 25% by weight relative to the weight of the product.

7. The agricultural product according to claim 1, wherein it comprises at least one additive, said additive being able to be chosen from lubricating agents, matrix plasticizing agents and cohesive agents.

8. The agricultural product according to claim 1, wherein the agricultural active ingredient(s) are chosen from fertilizers, natural defense stimulators, herbicides, fungicides, insecticides, parasiticides, repellents, and are chosen from or resulting from natural substances of plant, animal, microbial or mineral origin.

9. The agricultural product according to claim 1, wherein it comprises urea, in a proportion of 5% to 25% by weight relative to the weight of the product.

10. The agricultural product according to claim 1, wherein it is in the form of granules, tablets or pellets.

11. The agricultural product according to claim 1, wherein it meets at least one of the following properties: abrasion resistance at least equal to 98%, tensile elastic modulus at least equal to 200 MPa and less than 1850 MPa, bending elastic modulus at least equal to 85 MPa and less than 1500 MPa, Shore D surface hardness of between 37.5° and 70°, weight gain from 35% to 60% after 1 h of immersion in water, from 60% to 100% after 3 h, and from 100% to 160% after 6 h.

12. A method of manufacturing an agricultural product according to claim 1, wherein it is implemented in a twin-screw extruder comprising a barrel inside which are disposed two co-rotating and co-penetrating (or interpenetrated) parallel screws, and equipped with at least two inlets for feeding, an outlet for the extruded product and heating elements, said extruder being optionally associated with a die of the extruded product, and it comprises the following steps:
introduction of at least one plant-origin material and one agricultural active ingredient, and optionally one or more additives, in a first feed inlet of said extruder and premix of them by action of interpenetrating conveyor screws;
addition of water, and optionally of one or more additives, to the premix through a second feed inlet;
heating to a temperature of at least 80° C. to obtain a homogeneous mixture;
application of compressive, kneading and shearing stresses to said mixture by action of the screws; and
densification of the extruded product, recovered at the outlet of the extruder or die, to obtain said agricultural product.

13. The method according to claim 12, wherein the proportion of the plant-origin material and optionally of the additives, in the premix is at least 75% by weight relative to the weight of the premix and the proportion of the agricultural active ingredients in the premix is at most 25% by weight relative to the weight of the premix.

14. The method according to claim 12, wherein the water is added to the premix in a proportion of 20% to 50% by weight relative to the weight of the premix.

15. The method according claim 12, wherein the extruder is equipped with several series of decrease pitch conveyor screws, making it possible to apply the compressive stresses to said mixture.

16. The method according to claim 15, wherein the extruder is equipped with two successive pairs of bilobed kneading discs, mounted in a staggered fashion, making it possible to apply the kneading stresses to said mixture, said discs being disposed following, directly or indirectly, pitch decrease conveyor screws.

17. The method according to claim 16, wherein the extruder is equipped with several successive pairs of reverse pitch elements (or counter-threads), making it possible to apply the shearing stresses to said mixture, said elements being disposed following, directly or indirectly, said discs.

18. The method according to claim 12, wherein the agricultural active ingredient contains or consists of urea.

19. The method according to claim 12, wherein it comprises a step of adding urea, in a proportion of 5% to 20% by weight relative to the weight of the premix.

20. The method according to claim 12, wherein, after recovery of the product at the outlet of the extruder, it comprises a step of drying the agricultural product to reach a moisture level of between 15% and 20% by weight relative to the weight of the product.

21. The method according to claim 12, wherein the densification of the extruded product is carried out by thermoplastic injection or hot compression.

22. The method according to claim 21, wherein it comprises a step of plastic injection of the product, and the product is gradually heated, to a temperature of between 110° C. and 140° C., before injection molding.

23. A plant-origin material which has a plant protein content of at least 30% relative to the dry weight of said material and a lipid content of at most 10% relative to the dry weight of said material, configured as a disintegrable matrix to support an agricultural active ingredient.

24. A plasticizing agent comprising urea for the manufacture in a twin-screw extruder of an agricultural product as defined in claim 1.
